(19) United States
(12) Patent Application Publication
(10) Pub. No.: US 2019/0156234 A1
(43) Pub. Date: May 23, 2019

(54) SYSTEMS AND METHODS FOR PERFORMING REAL-TIME CONVOLUTION CALCULATIONS OF MATRICES INDICATING AMOUNTS OF EXPOSURE

(71) Applicant: Aon Global Operations Ltd (Singapore Branch), Singapore (SG)

(72) Inventors: Stephen John Martin Mildenhall, Oak Park, IL (US); Kirk William Dybvik, Chaska, MN (US)

(73) Assignee: Aon Global Operations Ltd (Singapore Branch), Singapore (SG)

(21) Appl. No.: 16/240,538

(22) Filed: Jan. 4, 2019

Related U.S. Application Data
(63) Continuation of application No. 15/460,985, filed on Mar. 16, 2017.
Application No. 15/460,985 is a continuation-in-part of application No. 14/062,277, filed on Oct. 24, 2013, now abandoned.

(51) Int. Cl. G06N 7/00; G06F 17/14; G06Q 40/08; G06F 17/15

(52) U.S. Cl. CPC G06N 7/005; G06F 17/153; G06Q 40/08; G06F 17/141

(57) ABSTRACT

In an illustrative embodiment, systems and methods for determining exposure include detecting, based on received data from external entities, an occurrence of a catastrophic event. Responsive to detecting the occurrence, a first matrix is generated indicating features of one or more properties within a vicinity of the catastrophic event, and a second matrix is generated representing characteristics of the catastrophic event. Using the first matrix and the second matrix, a convolution calculation matrix is calculated indicating amounts of correspondence between the first matrix and the second matrix. In real time, in response to detecting the occurrence of the catastrophic event, risk exposure information is presented to at least one remote computing system associated with at least one property of the plurality of properties, where the risk exposure data relates to the amount of correspondence between the first matrix and the second matrix in reference to the at least one property.

### CROSS-REFERENCE TO RELATED APPLICATIONS

This application is a continuation of U.S. application Ser. No. 15/460,985, entitled “Systems and Methods for Performing Real-Time Convolution Calculations of Matrices Indicating Amounts of Exposure,” filed Mar. 16, 2017, which is a continuation-in-part of and claims the benefit of priority from U.S. application Ser. No. 14/062,277, entitled “Systems and Methods for Determining Risk Exposure,” filed Oct. 24, 2013. All above identified applications are incorporated herein by reference in their entirety.

### BACKGROUND

The present technology relates to systems and methods for determining risk exposure of points of interest such as e.g., insured locations based on the occurrence of an event (e.g., a catastrophic event).

It is known that models or other computer applications may be used to assess the potential liabilities of catastrophic events. These events may be either man-made (e.g., terrorist attack) or naturally occurring disasters such as e.g., earthquakes, tornados, and hurricanes.

Certain companies, such as insurance companies, may find information provided by these models/applications useful in determining their potential liability (i.e., risk exposure) based on the occurrence of the event. These models/applications use, generate and store large amounts of data that need to be processed and analyzed to facilitate the determination of its potential liabilities based on the event. The existing methods are also time consuming. As such, there is a need and desire for a better system and method for determining risk exposure of e.g., insured locations based on the occurrence of an event such as a catastrophic event.

### SUMMARY OF ILLUSTRATIVE EMBODIMENTS

The forgoing general description of the illustrative implementations and the following detailed description thereof are merely exemplary aspects of the teachings of this disclosure, and are not restrictive.

The implementations described herein are directed toward an exposure determination system and environment that performs a convolution calculation of matrices that are generated at runtime in response to detection of a particular type of event. The matrices include a location matrix indicating features of one or more locations associated with the event and a spatial footprint matrix that represents characteristics of the event. A result of the convolution calculation of the matrices indicates an amount of exposure for the one or more locations in light of the detection of the event.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates one example of a computing device system of the present technology;

FIG. 2 illustrates one example of points of interest illustrated with an overlying grid;

FIG. 3 illustrates one example of a grid with cells containing exposure summations based on the points of interest illustrated in FIG. 2;

FIG. 4 illustrates an example event footprint superimposed over a footprint grid;

FIG. 5 illustrates an example of shape coverage factors for the cells within the footprint grid illustrated in FIG. 4;

FIG. 6 illustrates an example data grid having an apron including kernel padding cells around the insured location grid of FIG. 3, and example anchoring techniques for a kernel;

FIG. 7 illustrates an example grid having cells filled with convolution results;

FIG. 8 illustrates an environment for an exposure determination system; and

FIG. 9 is a flowchart of an exposure determination process.

### DETAILED DESCRIPTION OF ILLUSTRATIVE EMBODIMENTS

The description set forth below in connection with the appended drawings is intended as a description of various embodiments of the disclosed subject matter and is not necessarily intended to represent the only embodiments. In certain instances, the description includes specific details for the purpose of providing an understanding of the disclosed embodiments. However, it will be apparent to those skilled in the art that the disclosed embodiments may be practiced without those specific details. In some instances, well-known structures and components may be shown in block diagram form in order to avoid obscuring the concepts of the disclosed subject matter.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “proximate,” “minor,” and similar terms generally refer to ranges that include the identified value within a margin of 20%, 10% or preferably 5% in certain embodiments, and any values therebetween. The technology disclosed herein provides the capability to determine risk exposure or other statistical or characteristics of “points of interest” (e.g., insured locations) when the points of interest have been exposed to an event such as e.g., a catastrophic event that triggers insurance coverage. One existing application for determining risk exposure places a given set of insured locations on a map and creates a spatial “footprint” of the event. The footprint has a certain shape (i.e., polygon) and size based on the event. The application then uses the footprint and the map to determine the insured locations with the largest amount of exposure (i.e., locations covered by the footprint having the most liability for the insurance carrier).

The application associates a grid of cells with the map of insured risks, and partitions the insured locations into different grid cells. The grid cells are set to a specified width and height based on latitude and longitude; and the insured locations within each of the cells are identified. The spatial footprint of the event is also partitioned into a grid having the same resolution as the map's grid. Using a process based on an SQL database, the intersection of the spatial footprint grid cells and the insured locations' grid cells is calculated. The spatial footprint is moved across the grid of insured locations and anchored at various locations along the map grid.

Exposure of map grid cells covered by the spatial footprint is then calculated. By comparing the aggregations from each anchor point, one could identify the anchor points where the exposure was at its highest values. It should be appreciated that the principles disclosed herein can do more than identify the highest exposure values; for example, the disclosed principles provide the ability to identify the whole range of exposure values (e.g., all anchor points greater than one billion dollars, two billion dollars, etc.). This whole distribution is then a key factor in determining the exceedance probability (BP) distribution of potential losses.

One major shortcoming of the current approach is that it takes a long time to run its analysis. As can be appreciated, this shortcoming is very undesirable and needs to be addressed.

As recognized by the present inventors, the risk exposure determination process could be performed in a different and much more beneficial manner using a process known as convolution or moving window analysis. As is known in the art, convolution is a processing technique that takes a kernel of coefficients or weights (usually a matrix) and applies it to a set of points (e.g., pixels in an image) to calculate values for each point. The value for a point typically includes multiplying the point and its neighbors with the coefficients/weights in the kernel. The sums of the multiplications are added and stored as that point's value.

In the disclosed convolution risk exposure determination technique, points of interest (e.g., insured locations) are represented by a first grid, referred to herein as the insured location grid or location grid for convenience purposes only. In addition, the event footprint can be represented by a second grid, referred to herein as a spatial footprint grid or event footprint grid for convenience purposes only. As will become apparent, the grids can be used to generate a spatial footprint kernel (discussed below in more detail) that is then used in a moving window analysis to generate values of risk exposure for each insured location within the first grid. A final determination of where the risk exposure is the greatest can be made from the risk exposure values at each location.

Various examples of the present disclosure may be implemented with computing device devices, computing device networks and systems that exchange and present information.

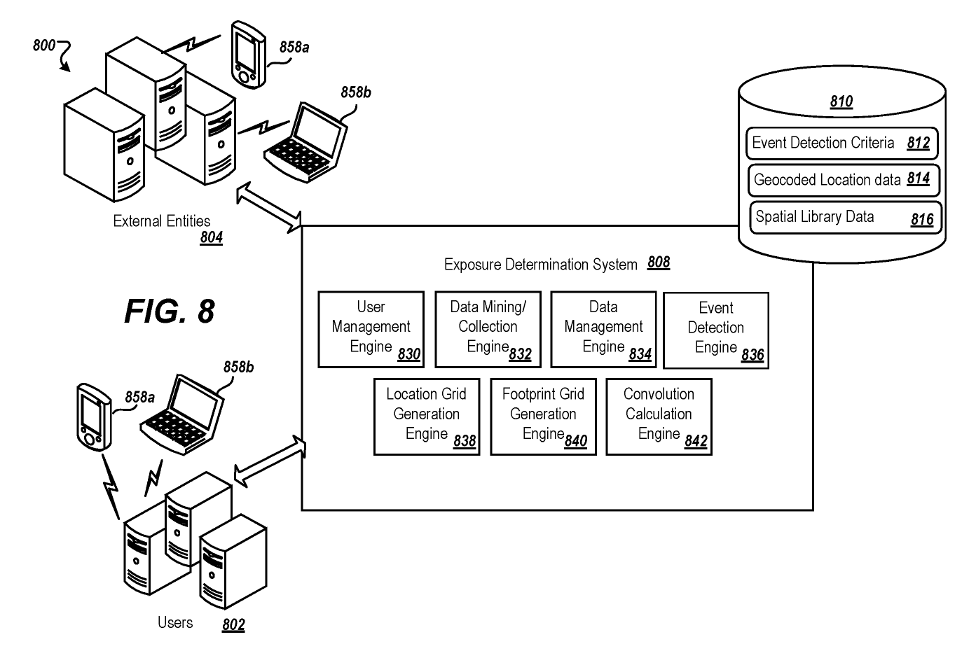

FIG. 8 is a diagram of an example environment 800 for an exposure determination system 808. The diagram illustrates a series of interactions between one or more participants and the exposure determination system 808, which determines risk exposure or characteristics of points of interest when the points of interest have been exposed to an event that can include a catastrophic event or any type of event that triggers insurance coverage. For example, an event can include natural disasters such as hurricanes, floods, tornadoes, or forest fires. In another example, the event can include a man-made event such as meltdown of a nuclear energy facility, terrorist attack, infrastructure failure (e.g., bridge failure, dam failure, large scale arson, etc.), or act of warefare.

In one implementation, in response to detecting an occurrence of a catastrophic event, the exposure determination system 808 determines the risk exposure of insured entities at one or more locations based on a convolution of an insured location grid with a spatial footprint grid indicating an effect of the event on an area. A result of the convolution calculation, the exposure determination system 808 may provide an indication of insured locations that may be at risk for submitting insurance claims based on the event occurrence. In addition, the insured location grid and the spatial footprint grid may be defined as matrices that are generated in real-time for each detection of an event occurrence, which reduces an amount of data repository storage space that is used during execution of the processes of the exposure determination system 808 and also ensures that excessive amounts of processing are not performed due to large grid sizes of manually-stored, pre-generated grids. This on-the-fly generation of the insured location grid and the spatial footprint grid as well as the processing efficiency of the convolution calculation that uses discrete Fourier transform (DFT) techniques allows the exposure determination system 808 to operate more efficiently than other risk exposure calculation systems known in the art. The increase in processing capability afforded by the grid generation and convolution techniques described further herein also allow the exposure determination system 808 to operate in real-time to make risk exposure determinations in response to detecting an event occurrence.

Users 802, in some embodiments, include a number of computing devices and databases distributed across a widely dispersed network that may be distributed across a large, international geographic area. The user network can be separate and independent from any network associated with any other participant in the exposure determination environment 800, such as external entities 804. In addition, the data handled and stored by the users 802 may be in a different format than the data handled and stored by the other participants of in the exposure determination environment 800. The users 802 can include, in some examples, insured personnel, brokers, insurance carriers, or any other person providing inputs to the exposure determination system 808. These inputs, in some examples, may include information regarding insurance coverage levels, risk exposure, or claims data. The users 802 may access the exposure determination system 808 via computing devices 858 that are connected to the system 808 via any type of wired or wireless network.

External entities 804, in some implementations, include a number of computing devices and databases distributed across a widely dispersed network that may be distributed across a large, international geographic area. The external entity network can be separate and independent from any network associated with any other participant in the exposure determination environment 800, such as the users 802. In addition, the data handled and stored by the external entities 804 may be in a different format than the data handled and stored by the other participants of in the exposure determination environment 800. The external entities 804 can include any type of external system that provides data regarding catastrophic event occurrences such as government or private weather monitoring systems, first responder data systems, or law enforcement data systems. The external entities 804 may connect to the exposure determination system 808 via computing devices 858 that are connected to the system 808 via any type of wired or wireless network. In some embodiments, external entities 804 may supply data into the exposure determination system 808 (e.g., on a periodic basis or responsive to occurrence of a catastrophic event). In some embodiments, the exposure determination system 808 connects to one or more external entities 804 to request or poll for information. For example, the exposure determination system 808 may be a subscriber of information supplied by one or more of the external entities 804, and the exposure determination system 808 may log into one or more of the external entities 804 to access information.

The exposure determination system 808 includes one or more engines or modules that perform processes associated with determining amount of risk exposure for insured locations in response to catastrophic events. References to the engines or modules throughout the disclosure are meant to refer to software processes executed by circuitry of one or more processing circuits, which can also be referred to interchangeably as processing circuitry. In one example, a user management engine 830 includes one or more processes associated with providing an interface to interact with the users 802 within the exposure determination environment 800. The processes performed by the engines of the exposure determination system 808 can be executed in real-time in order to provide an immediate response to a system input. In addition, the processes can also be performed automatically in response to a process trigger that can include the reception of data from a data repository, a participant, or another processing engine. For example, the user management engine 830 can control connection and access to the exposure determination system 808 by the users 802 via authentication interfaces at one or more external devices 858 of the users 802 and/or external entities 804.

The exposure determination system 808, in some implementations, also includes a data mining/collection engine 832 that controls the gathering of survey data from the users 802 and external entities 804. In some implementations, the data mining/collection engine 832 receives data from one or more sources that may cause the detection of a catastrophic event. For example, the data mining/collection engine 832 may be capable of receiving automatically and/or continuously updated data from first responder data systems or weather data systems to detect when catastrophic events occur. In addition, the data mining/collection engine 832 may be capable of performing web crawling processes to access the updated data from one or more websites associated with providing data about catastrophic events. In addition, the data mining/collection engine 832 may be configured to receive manually entered information from the users 802, which can include insurance claim data or insurance coverage information.

In addition, the exposure determination system 808, in some embodiments, includes a data management engine 834 that organizes the survey data received by the exposure determination system 808 and also controls data handling during execution of the processes associated with determining risk exposure at one or more locations due to occurrences of catastrophic events. In some implementations, the data management engine 834 processes the data received by the data mining/collection engine 832 and loads received data files to event footprint data 818, which can be a database of data files received from the external entities 804 regarding catastrophic event coverage areas and severity throughout the coverage areas. In addition, the data management engine 834 may perform a data validation/normalization process to configure the received data into a predetermined format compatible with a format of the files within the event footprint data 818.

In some implementations, the data management engine 834 also controls the interaction of the exposure determination system 808 with a data repository 810 associated with the exposure determination environment 800 and can also access any of the data from the data repository 810 for use by the exposure determination system 808. For example, data generated during the execution of one or more processes by exposure determination system 808 can be stored in data repository 810, and the data management engine 834 may control the flow of data between the data repository 810 and the exposure determination system 808.

The exposure determination system 808, in some embodiments, also includes an event detection engine 836 that detects occurrences of catastrophic events that can result in payment of claims by an insurance carrier. The catastrophic events can be detected based on event detection criteria 812 that are stored in the data repository 110. The event detection criteria 812 can include a category of event (e.g., man-made or natural), a type of event (e.g., tornado, hurricane, or terrorist attack), an event severity level that is based on various factors based on the type of event, or a coverage area of the event. When one or more event detection criteria are met such as when one or more characteristics of the event exceed thresholds associated with the event detection criteria, then the event detection engine 836 determines that a catastrophic event has occurred.

In some implementations, the exposure determination system 808 also includes a location grid generation engine 838 that generates location grids in response to detection of a catastrophic event at a particular location. In some implementations, the location grids are two-dimensional matrices that represent insured locations, also referred to as points of interest, throughout the location where the catastrophic event occurred. For example, cells of the location grid can correspond to amounts of risk exposure effecting the points of interest, which can be filtered by the location grid generation engine 838 based on characteristics of the catastrophic event or other predetermined criteria. In addition, the location grid generation engine 838 can determine a size of the location grid for a catastrophic event based on characteristics of the catastrophic event. For example, tornado tracks range in length from less than a mile to over fifty miles and are up to one mile wide. Therefore, in one example, a resolution for the cells of the location grid may be one mile-by-one mile or smaller.

In some implementations, generation of the location grid is performed at runtime in response to a catastrophic event detection—rather than beforehand—which allows for the flexibility of filtering the data for various criteria, allows for flexibility of the grid resolution, eliminates the manual process of creating the grid, and eliminates the storage requirements for the grid and any intermediate results. In one embodiment, the grid can be generated at runtime from a SQL database of stored, geocoded location data 814. By scaling and rounding the geocoded latitude and longitude appropriately, a new grid can be produced very efficiently as a table, which can then be transformed into matrix form. Details regarding the generation of location grids are discussed further herein.

In some embodiments, the exposure determination system 808 also includes a footprint grid generation engine 840 that generates a spatial footprint grid in response to detection of a catastrophic event. In some implementations, the footprint grid generation engine 840 generates the spatial footprint grid using the characteristics of the detected catastrophic event along with spatial library data 816 that provides template shapes that are used to represent the catastrophic events in the spatial footprint grid. In one embodiment, generation of the spatial footprint grid can be performed at runtime (e.g., in a similar manner that the location grid is generated), which allows for the flexibility of selecting shapes from the spatial library data 816 without having to manually process the shape. This also removes the need to store the grid cell coordinates in a database. Details regarding the spatial footprint grid are discussed further herein.

The exposure determination system 808, in some implementations, also includes a convolution calculation engine 842 that executes convolution operations between the location grid and the spatial footprint grid. Once the location grid and spatial footprint grid are generated, the grids may be formatted in a way to apply convolution processing to complete the risk exposure determination analysis. For example, convolution problems lend themselves to techniques of discrete Fourier transforms (DFTs). The most common fast convolution algorithms use fast Fourier transform (FFT) algorithms via the circular convolution theorem. That is, the circular convolution of two finite-length sequences is found by taking an FFT of each sequence, multiplying point-wise, and then performing an inverse FFT. The spatial footprint grid is moved across the location grid, and convolution calculations are performed at various spatial footprint grid anchor points on the location grid. Each convolution calculation represents an amount of risk exposure to the catastrophic event at a corresponding anchor point due to an amount of correspondence between the location grid and the spatial footprint grid at the particular anchor point. The convolution calculation engine 842 outputs a resulting convolution calculation grid to the users 802 indicating the risk exposure results for the catastrophic event. Details regarding the convolution calculation operations are discussed further herein.

The exposure determination environment 800, as noted earlier, also includes the data repository 810. The data repository 810 may be th connected to the exposure determination system 808 via a wired or wireless network. In some implementations, the data repository 810 stores the event detection criteria 812, geocoded location data 814, spatial library data 816, and any other type of data associated with executing the processes of the exposure determination system 808. In addition, the data may be stored in formats that facilitate improved processing efficiency of the computing resources of the processing engines of the exposure determination system 808. For example, the geocoded location data 814 can be stored as a SQL database, which allows the location grid to be generated in real-time in response to a catastrophic event detection. Generating the location grid at runtime improves processing efficiency of the system 808 and reduces overall processing resources due to the reduced overhead of having to store manually generated location grid data in the data repository 810.

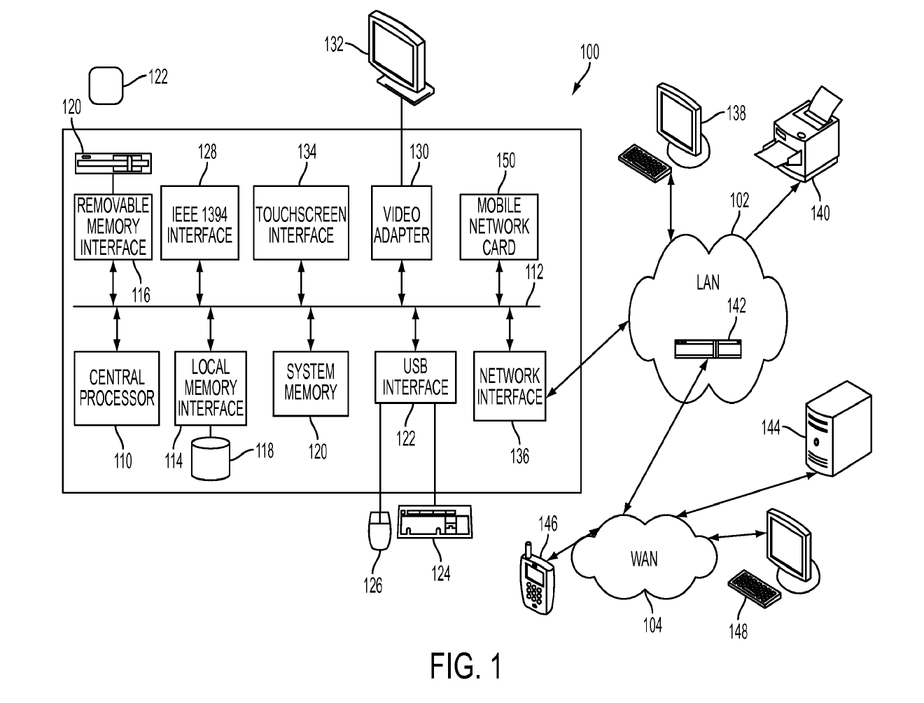

Elements of an exemplary computing device system are illustrated in FIG. 1, in which the convolution risk exposure determination functionality are provided to a user by a computing device 100. The computing device 100 can represent any of the computing devices of the exposure determination environment 800 described previously. Computing device 100 can be connected to a local area network (LAN) 102 and/or a wide area network (WAN) 104. Computing device 100 can include a central processor 110 that controls the overall operation of the computing device, and a system bus 112 that connects central processor 110 to the components described below. System bus 112 may be implemented with any one of a variety of conventional bus architectures.

Computing device 100 can include a variety of interface units and drives for reading and writing data or files. In particular, computing device 100 can include a local memory interface 114 and a removable memory interface 116 respectively coupling a hard disk drive 118 and a removable memory drive 120 to system bus 112. Examples of removable memory drives include magnetic disk drives and optical disk drives that receive removable memory elements 122. Hard disks generally include one or more read/write heads that convert bits to magnetic pulses when writing to a computing device-readable medium and magnetic pulses to. bits when reading data from the computing device readable medium. A single hard disk drive 118 and a single removable memory drive 120 are shown for illustration purposes only and with the understanding that computing device 100 may include several of such drives. Furthermore, computing device 100 may include drives for interfacing with other types of computing device readable media such as magneto-optical drives.

Unlike hard disks, system memories, such as system memory 120, generally read and write data electronically and do not include read/write heads. System memory 120 may be implemented with a conventional system memory having a read only memory section that stores a basic input/output system (BIOS) and a random access memory (RAM) that stores other data and files.

A user can interact with computing device 100 with a variety of input devices, and through graphical user interfaces provided to the user by the computing device 100, such as though a browser application. For example, FIG. 1 shows a universal serial bus (USB) interface 122 coupling a keyboard 124 and a pointing device 126 to system bus 112. Pointing device 132 may be implemented with a hard-wired or wireless mouse, track ball, pen device, or similar device.

Computing device 100 may include additional interfaces for connecting peripheral devices to system bus 112. FIG. 1 shows a IEEE 1394 interface 128 that may be used to couple additional devices to computing device 100. Peripheral devices may include game pads scanners, printers, and other input and output devices and may be coupled to system bus 112 through parallel ports, game ports, PCI boards or any other interface used to couple peripheral devices to a computing device.

Computing device 100 also includes a video adapter 130 coupling a display device 132 to system bus 112. Display device 132 may include a cathode ray tube (CRT), liquid crystal display (LCD), field emission display (FED), plasma display or any other device that produces an image that is viewable by the user. A touchscreen interface 134 may be included to couple a touchscreen (not shown) to system buss 112. A touchscreen may overlay at least part of the display region of display device 132 and may be implemented with a convention touchscreen technology, such as capacitive or resistive touchscreen technology.

One skilled in the art will appreciate that the device connections shown in FIG. 1 are for illustration purposes only and that several of the peripheral devices could be coupled to system bus 112 via alternative interfaces. For example, a video camera could be connected to IEEE 1394 interface 128 and pointing device 126 could be connected to another interface.

Computing device 100 may include a network interface 136 that couples system bus 112 to LAN 102. LAN 102 may have one or more of the well-known LAN topologies and may use a variety of different protocols, such as Ethernet. Computing device 100 may communicate with other computing devices and devices connected to LAN 102, such as computing device 138 and printer 140. Computing devices and other devices may be connected to LAN 102 via twisted pair wires, coaxial cable, fiber optics or other media. Alternatively, electromagnetic waves, such as radio frequency waves, may be used to connect one or more computing devices or devices to LAN 102.

A wide area network 104, such as the Internet, can also be accessed by computing device 100. FIG. 1 shows network interface 136 connected to LAN 102. LAN 102 may be used to connect to WAN 104. FIG. 1 shows a router 142 that may connect LAN 102 to WAN 104 in a conventional manner. A server 144. Mobile terminal 146 and a computing device 148 are shown connected to WAN 104. Of course, numerous additional servers, computing devices, handheld devices, personal digital assistants, telephones and other devices may also be connected to WAN 104.

In some examples, a mobile network card 150 may be used to connect to LAN 102 and/or WAN 104. Mobile network card may be configured to connect to LAN 102 and/or WAN 104 via a mobile telephone network in a conventional manner.

The operation of computing device 100 and server 144 may be controlled by computing device-executable instructions stored on a non-transient computing device readable medium. For example, computing device 100 may include computing device-executable instructions stored on a memory for transmitting information to server 144, receiving information from server 144 and displaying the received information on display device 132. Furthermore, server 144 may include stored on a memory computing device-executable instructions for, receiving requests from computing device 100, processing data and transmitting data to computing device 100. In some embodiments server 144 transmits hypertext markup language (HTML) and extensible markup language (XML) formatted data to computing device 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102 and 104, but also a “content network,” which includes the data—attributable to a single entity—which resides across all physical networks.

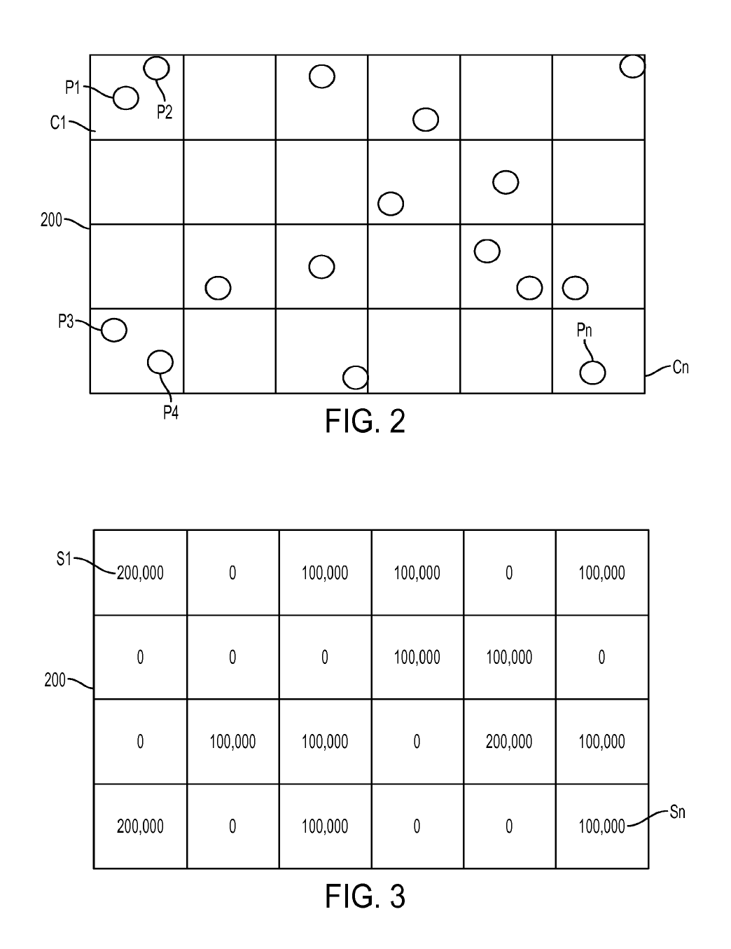

An example of the disclosed convolution risk exposure determination is now described with reference to FIGS. 2-7. FIG. 2 illustrates one example of points of interest P1, P2, . . . , Pn illustrated with an overlying grid 200. In the present example, the points of interest P1, P2, . . . , Pn are insured locations within a region associated with the grid 200 and each insured location is associated with a particular amount of insurance coverage (i.e., risk exposure). In the illustrated embodiment, each point of interest P1, P2, . . . , Pn corresponds to $100,000 of exposure. It should be appreciated that this is an example amount of exposure and that any amount could be used. The grid 200 contains an array of cells C1, . . . , Cn, which can be configured/sized to represent regions of interest (e.g., specific cities, regions on a map, etc.). It is desirable, for example, for the grid to be tight enough to capture the exposure distribution on the scale of a tornado. Tornado tracks generally range in length from less than a mile to over fifty miles and are up to one mile wide. Therefore, in one embodiment, the grid 200 resolution is one mile-by-one mile or smaller. It should be appreciated that the grid 200 can have more or fewer rows/columns than those illustrated and that the disclosed embodiment is not to be limited to any particular grid size. In one embodiment, the preparation of the insured location grid 200 is done at runtime—rather than beforehand—which allows for the flexibility of filtering the data for various criteria, allows for flexibility of the grid resolution, eliminates the manual process of creating the grid, and eliminates the storage requirements for the grid and any intermediate results. In one embodiment, the grid can be generated at runtime from a SQL database of stored, geocoded locations. By scaling and rounding the geocoded latitude and longitude appropriately, a new grid can be produced very efficiently as a table, which can then be transformed into matrix form.

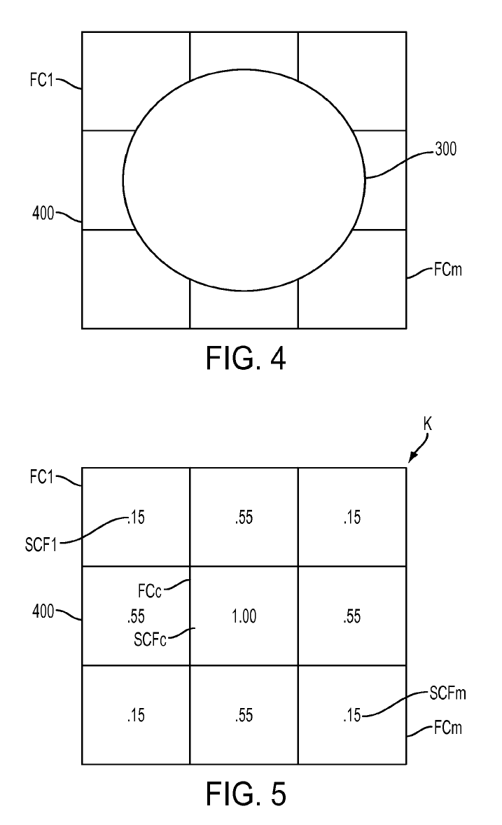

FIG. 3 illustrates one example of the grid 200 with cells C1, . . . , Cn containing exposure summations S1, . . . , Sn based on the points of interest P1, P2, Pn illustrated in FIG. 2. In the illustrated example, the first cell C1 has a summation S1 of $200,000 based on the summation of the exposures of points P1 and P2. It should be appreciated that the contents of the cells are not limited to summations and could, alternatively or additionally, include other mathematical operations or relationships of the data and/or other statistical data if desired.

FIG. 4 illustrates an example event footprint 300 superimposed over a footprint grid 400. In the illustrated example, the footprint 300 is shown as being a circle, but it should be appreciated that any shape (e.g., square, rectangle, polygon, etc.) can be used to represent the footprint of the event. Moreover, the footprint could actually be represented as a set of nested polygons, so that a different percentage of the exposed risks located within each polygon could contribute to the aggregate total. The footprint grid 400 includes an array of footprint cells FC1, . . . , FCm. The footprint cells FC1, . . . , FCm have the same size (i.e., dimensions) as the insured location cells C1, . . . , Cn illustrated in FIGS. 2 and 3. In the illustrated embodiment, the grid 400 includes a 3×3 array of footprint cells FC1, . . . , FCm. It should be appreciated that the footprint grid 400 can have more or fewer than three rows/columns and that the disclosed embodiment is not to be limited to any particular array or array size. As will be discussed below in more detail, the footprint grid 400 will be used as a kernel for the disclosed convolution technique.

The event footprint 300 is then used to determine the ratio/amount of each footprint cell's FC1, . . . , FCm area that is covered by the shape of the footprint 300. These ratios are referred to herein as the shape coverage factors. FIG. 5 illustrates an example of shape coverage factors SCF1, . . . , SCFm for the cells FC1, . . . , FCm within the footprint grid 400 illustrated in FIG. 4. As noted above, the footprint grid 400 and its shape coverage factors are used as a kernel K in subsequent convolution processing. As can be seen, the first and last footprint cells FC1, FCm (and others) have a shape coverage factor SCF1, SCFm of 0.15 (i.e., only 15% of their respective areas are covered by the footprint 300) while the center footprint cell FCc has a shape coverage factor SFCc of 1.0 (i.e., 100% of its area is covered by the footprint 300). In one embodiment, the preparation of the footprint grid 400 can be done at runtime (e.g., in a similar manner that grid 200 is created), which allows for the flexibility of selecting shapes from a spatial library without the need to manually process the shape. This also removes the need to store the grid cell coordinates in a database, and also allows for retaining information such as the shape coverage factors SCF1, . . . , SCFm.

Once the two grids 200, 400 are generated, they are formatted in a way to apply convolution processing to complete the risk exposure determination analysis. For example, convolution problems lend themselves nicely to the techniques of discrete Fourier transforms (DFTs). The most common fast convolution algorithms use fast Fourier transform (FFT) algorithms via the circular convolution theorem. That is, the circular convolution of two finite-length sequences is found by taking an FFT of each sequence, multiplying point-wise, and then performing an inverse FFT. An open source project called FFTW (Fastest Fourier Transform in the West—http://fftw.org) is an example of a library of computer applications that can be used for DFT calculations. There are other similar libraries available, a few examples are cufft from NVidia (https://developer.nvidia.com/cufft) and applications in the Intel Math Kernel Library (http://software.intel.com/sites/products/documentation/hpc/mkl/mklman/GUID-BE3BF27D-D852-4C7 A-BD38-4409D54E1B1A.htm).

Since the kernel K (i.e., footprint grid 400 containing the shape coverage factors SCF1, . . . , SCFm) will be applied against the insured location grid 200 via e.g., circular convolution, it is desired that padding should be added to the insured location grid 200 to avoid a “wrap around” effect that could adversely impact the convolution results. This padding is referred to herein as an apron and is a function of the dimensions of the kernel/footprint grid's 400 shape.

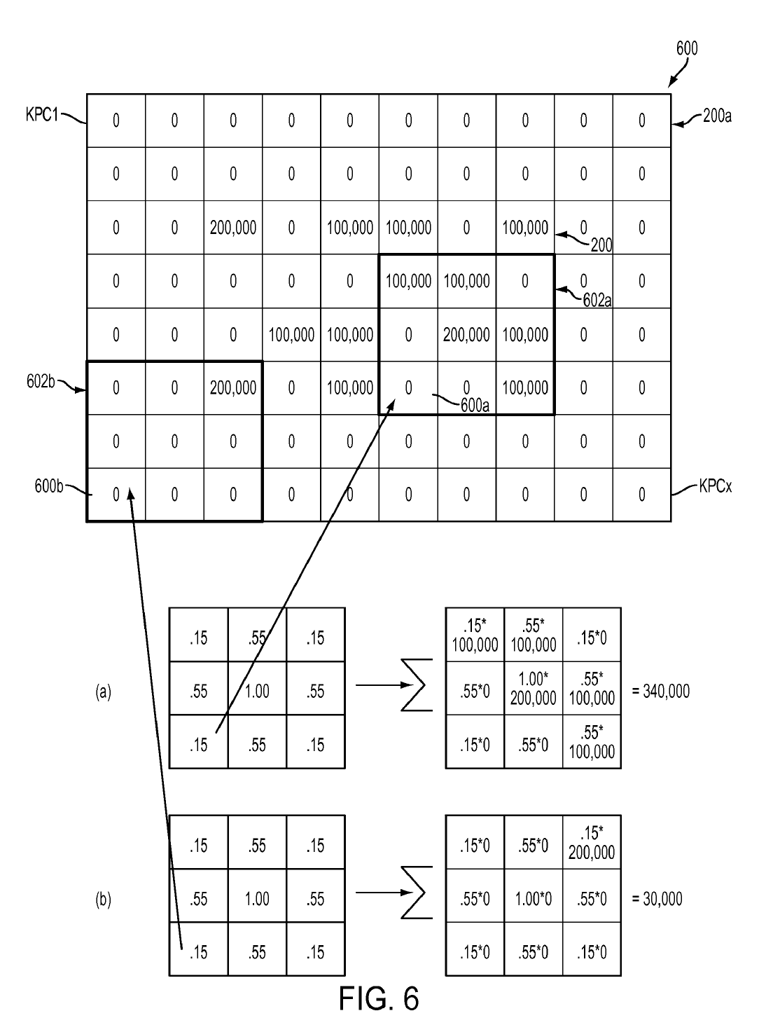

FIG. 6 illustrates an example data grid 600 having an apron 200a including kernel padding cells KPC1, . . . , KPCx around the insured location grid 200. FIG. 6 also illustrates example anchoring techniques for a kernel (discussed below in more detail). One of skill in the art will appreciate that since the kernel/footprint grid 400 is a 3×3 matrix, the outside cells (e.g., Cl, Cn) of the insured location grid 200 need to be padded by two cells. As such, the grid 600 illustrated in FIG. 6 has an apron including two columns to the left of the first column in the insured location grid 200, two columns to the right of the last column in the insured location grid 200, two rows above the first row in the insured location grid 200, and two rows below the last row in the insured location grid 200.

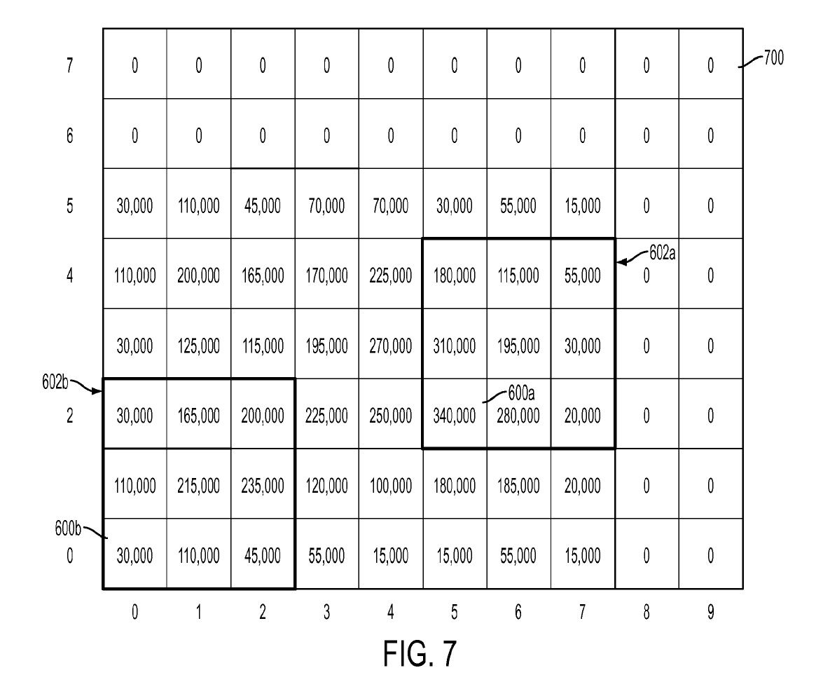

Once the data grid 600 is prepared, convolution processing may begin. Specifically, the kernel K (i.e., footprint grid 400 and its shape coverage factors SCF1, . . . , SCFm) is moved across the grid 600 to provide convolution results to each cell in the manner described below. In one embodiment, the bottom left cell in the kernel K is anchored to a cell within the grid 600. The kernel's K shape coverage factors SCF1, . . . , SCFm are then multiplied with the summations in the grid 600 cells covered by the kernel (it should be appreciated that the summations for apron cells is 0). All of these values (i.e., products) are then added together and that sum (i.e., the convolution result) is associated with the cell the kernel K is anchored to. For example, in situation (a), the kernel K is anchored at cell 600a and multiplied with the summations in the cells within area 602a, and the products are added to achieve a convolution result for cell 600a (shown in FIG. 7). In situation (b), for example, the kernel K is anchored at cell 600b and multiplied with the summations in the cells within area 602b, and the products are added to achieve a convolution result for cell 600b. In addition, the kernel K can be applied to the grid 600 so that a convolution calculation is performed with each cell in the grid 600 as the anchor point in order to accurately represent all possible event coverage areas within the location grid. As noted above, it is desirable to implement this processing using DFFTs or FFTs with the grid 600 and kernel K as inputs. One of skill in the art would understand how to implement the convolution processing with DFTs or FFTs. The process is performed for each cell in the grid 600 (i.e., each cell is an anchoring point and obtains a convolution result by applying the kernel K to the appropriate cells).

FIG. 7 illustrates an example grid 700 with convolution results within its cells. As can be seen, the result in cell 600a is $340,000 (based on the calculations within area 602a) and the result in cell 600b is $30,000 (based on the calculations within area 602b). From these results, a determination of the highest risk exposure can be made.

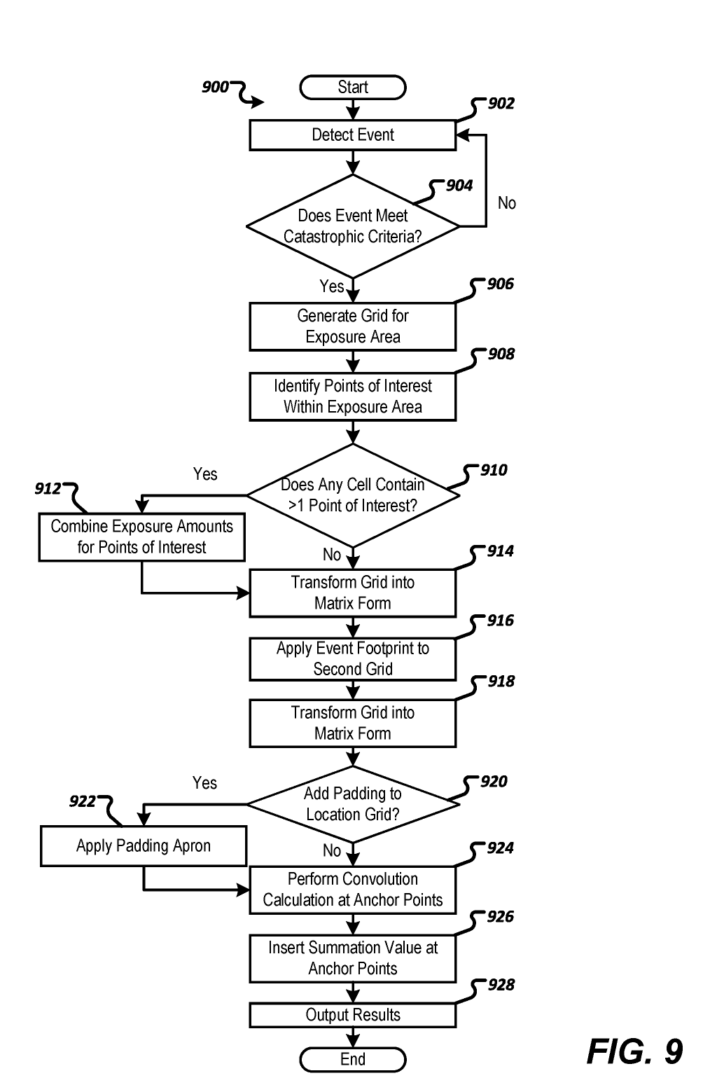

FIG. 9 is a flowchart of an example exposure determination process 900. The process 900, for example, may be executed by the processing engines of the exposure determination system 808. Although the flowchart illustrates blocks appearing in a particular order, it can be understood that the processes or steps associated with the various blocks can be performed in series or parallel or otherwise in a different order.

In some implementations, at least one event is detected (902). For example, the event detection engine 836 may detect occurrence of one or more catastrophic events that may result in payment of claims by an insurance carrier. Detection may be based on event data, such as event data received from one or more external entities 804. In some implementations, the catastrophic events are detected based on event detection criteria 812 that are stored in data repository 110. The event detection criteria 812 can include a category of event (e.g., man-made or natural), a type of event (e.g., tornado, hurricane, or terrorist attack), an event severity level that is based on various factors based on the type of event, or a coverage area of the event. For example, in the case of a hurricane, the severity level can be based on a total coverage area of the hurricane, wind speed at various times and locations, as well as other factors.

In some implementations, at least one event is deemed a catastrophic event (904). For example, based upon determining that one or more event detection criteria are met such as when one or more characteristics of the event exceed thresholds associated with the event detection criteria, the event detection engine 836 may determine that a catastrophic event has occurred. If it is determined that the detected event does not meet event detection criteria, then the process returns to detecting events (902).

In response to detecting that at least one catastrophic event has occurred, in some implementations, a grid is generated for an exposure area of each catastrophic event (906). For example, the location grid generation engine 838 may generate a location grid for an exposure area, such as the grid 200 in FIG. 2 based on characteristics of the catastrophic event that indicate affected locations. The identification of affected locations, for example may be based on the geocoded location data 812 stored in the data repository 810. In an example, the grid 200 includes an array of cells C1, . . . , Cn, which can be configured/sized to represent regions of interest (e.g., specific cities, regions on a map, etc.). In some implementations, the grid 200 is generated at runtime rather than beforehand to allow for the flexibility for filtering the data for various criteria, allows for flexibility of grid resolution, eliminates the manual process of creating the grid, and eliminates storage requirements for the grid and any intermediate results.

In some implementations, point(s) of interest within each exposure area are identified (908). The location generation engine 838, for example, may also identify one or more points of interest within the exposure area for the catastrophic event represented by the grid. For example the grid 200 in FIG. 2 includes the points of interest P1, P2, . . . , Pn, which represent insured locations within a region associated with the grid 200, and each insured location is associated with a particular amount of insurance coverage (i.e., risk exposure). For example, each point of interest, P1, P2, . . . , Pn corresponds to $100,000 of exposure.

If any cell within the grid contains more than one point of interest (910), then the exposure amounts for each of the points of interest are summed to produce a total exposure amount for the cell (912). For example, the grid 200 of FIG. 2 includes P1 and P2 in cell C1.

In some implementations, the grid 200 is transformed into matrix form (914). For example, by scaling and rounding the geocoded latitude and longitude data appropriately, the grid 200 of FIG. 2 can be transformed into matrix form, where the total exposure amount for each cell in the grid corresponds to an entry in the matrix, as illustrated in FIG. 3.

In response to detecting that a catastrophic event has occurred, in some implementations, the event footprint is applied to a second grid (916). The footprint grid generation engine 840, for example, may generate a second grid for the catastrophic event referred to as a spatial footprint grid by applying an event footprint to the spatial footprint grid. In some implementations, the footprint grid generation engine 840 generates the event footprint to apply to the spatial footprint grid using the characteristics of the detected catastrophic event as along with spatial library data 816 that provides template shapes that are used to represent the catastrophic events in the spatial footprint grid. In the example illustrated by FIG. 4, event footprint grid 300 is superimposed over footprint grid 400. The footprint 300 is shown as being a circle, but a different shap shape (e.g., square, rectangle, polygon, etc.) can be used to represent the footprint of the event. In some implementations, the footprint can be a set of nested polygons so that a different percentage of the exposed risks located within each polygon may contribute to an aggregate total. The footprint grid 400 includes an array of footprint cells FC1, . . . , FCm, which have the same size (i.e., dimensions) as the insured location cells C1, . . . , Cn of the grid 200 illustrated in FIGS. 2 and 3. In the illustrated embodiment, the grid 400 includes a 3×3 array of footprint cells FC1, . . . , FCm.

In some implementations, the spatial footprint grid is transformed into matrix form (918). For example, the event footprint 300 may be used to determine the ratio/amount of each footprint cell's FC1, . . . , FCm area that is covered by the shape of the footprint 300. These ratios are referred to herein as the shape coverage factors. FIG. 5 illustrates an example of shape coverage factors SCF1, . . . , SCFm for the cells FC1, . . . , FCm within the footprint grid 400 illustrated in FIG. 4. The shape coverage factors for each cell of the footprint grid 400 represent entries of the corresponding matrix. The footprint grid 400 and its shape coverage factors can be used as a kernel K in subsequent convolution processing.

In some implementations, the kernel K (i.e., footprint grid 400 containing the shape coverage factors SCF1, . . . , SCFm) is applied against the insured location grid 200 during convolution processing. If it is determined that applying the kernel K against the grid produces an a “wrap around” effect that may negatively impact the convolution results (920), then a padding apron can be added to the location grid (922). The padding apron is a function of the dimensions of the shape of the kernel/footprint grid 400. For example, FIG. 6 illustrates an example data grid 600 having an apron 200a including kernel padding cells KPC1, . . . , KPCx around the insured location grid 200.

In some implementations, a convolution calculation is performed at anchor points (924). When convolution processing is performed, the kernel K (i.e., spatial footprint grid 400 having shape coverage factors SCF1, . . . , SCFm) may be moved across the grid 600 to provide convolution calculation results to each cell based on an anchor point of the kernel K. In one embodiment, the bottom left cell in the kernel K is anchored to a cell within the grid 600. The kernel's K shape coverage factors SCF1, . . . , SCFm are then multiplied with the summations in the grid 600 cells covered by the kernel (it should be appreciated that the summations for apron cells is 0).

In some implementations, a summation value is inserted at the anchor points (926). All of the values generated during the convolution calculation of step 924 (i.e., products), for example, are added together and that sum (i.e., the convolution result) is associated with the cell the kernel K is anchored to. For example, in situation (a), the kernel K is anchored at cell 600a and multiplied with the summations in the cells within area 602a, and the products are added to achieve a convolution result for cell 600a (shown in FIG. 7). In situation (b), the kernel K is anchored at cell 600b and multiplied with the summations in the cells within area 602b, and the products are added to achieve a convolution result for cell 600b. In addition, the kernel K can be applied to the grid 600 so that a convolution calculation is performed with each cell in the grid 600 as the anchor point in order to accurately represent all possible event coverage areas within the location grid.

The convolution calculation at each anchor represents an amount of risk exposure to the catastrophic event at that corresponding anchor point. In some implementations, the results of the convolution processing are output to an end user or system (928). The resulting convolution calculation grid, for example, may be output to the users 802 indicating the risk exposure results for the catastrophic event. In some implementations, the results can be output as a user interface screen that graphically represents the convolution calculation grid to a requesting user 802.

It should be appreciated that the present technology can be applied to more complex insurance policy structures such as those used by commercial insurance policies. The present technology can be adapted to handle more complex shapes that represent catastrophes or other events. It should be appreciated that the present technology may apply to a multitude of shapes (perhaps hundreds or thousands) through the application against the same portfolio of insured locations, if desired.

Compared to conventional risk exposure determination techniques, the risk exposure determinations described herein provide a more accurate representation of risk exposure while also improving a processing speed of calculating risk exposure. For example, variable resolution grid (VRG) techniques apply a single exposure risk ratio to an entire grid even if the catastrophic event only covered ten percent of the grid, which leads to an underestimation of concentration risk. To alleviate the inaccuracies caused by the underestimation, spider analyses are often run in parallel with the VRG techniques, which reduces efficiency of the processing resources of the system. Another risk exposure technique is a point in polygon technique that only takes into account exposures that occur within the event footprint and disregards exposures that occur outside the event footprint. The point in polygon technique also creates sharp geographical changes in the event footprint, which causes choppiness in the footprint at fine resolutions, which can be partially solved by using statistical techniques to smooth discontinuities from the resolution choppiness. Also, in order to accurately represent the event footprint, the point in polygon technique would have to run over 300 million simulations to produce accurate results, and current models are based on only around 1.5 million simulations.

Because the risk exposure determination system 808 generates the location grid and the spatial footprint grid at runtime, the size and resolution of the grids can be determined based on the dimensions of the event footprint so that estimation errors do not result. Also, the convolution calculation point is applied at each cell of the grid so that all possible exposure possibilities are calculated, even those that are outside of the direct coverage area of the catastrophic event. In addition, the FFT operations that are used with the convolution techniques described herein can be processed much faster than the conventional risk exposure determination techniques.

In addition, the implementations described by the present disclosure represent a technical solution to a technical problem of generating and manipulating large volumes of matrices without creating a data storage burden on the exposure determination system 808. In conventional implementations of risk exposure determination systems that perform risk exposure calculations using large, manually-stored matrices, the processing resources of the system become bogged down with accessing appropriate portions of the matrices associated with the catastrophic event and performing complex matrix calculations at matrix locations that are not applicable to the characteristics of the detected catastrophic event. Generating the location grid and spatial footprint grid at runtime improves an overall functionality of the processing resources. In addition, the implementations described herein with respect to exposure determination can also be applied to other technical fields, such as crime or military prediction tools where occurrences of various types of events can be used to predict a likelihood that other types of related events may subsequently occur.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

1. (canceled)

2. A system for performing real-time determinations of risk exposure associated with a plurality of geographic points of interest affected by a catastrophic event, the system comprising:
processing circuitry; and
a non-transitory computer readable memory coupled to the processing circuitry, the memory storing machine-executable instructions, wherein the machine-executable instructions, when executed on the processing circuitry, cause the processing circuitry to
receive, from a user at a remote computing device, a request for an assessment of risk exposure related to an occurrence of an event within a geographic region of interest, wherein the event is a natural or man-made catastrophic event,
identify one or more locations associated with the user,
generate, in real-time responsive to receiving the request from the remote computing device, an event location grid having a plurality of cells, wherein at least a portion of the cells correspond to a portion of the one or more locations affected by the event,
generate, in real-time responsive to receiving the request from the remote computing device, an event footprint grid representative of a geographic coverage area of the event, wherein the event footprint grid includes a plurality of cells having a resolution corresponding to a grid cell resolution of the event location grid,
compute, in real-time, an amount of risk exposure to the one or more locations due to the event based on execution of a convolution calculation of the event footprint grid with the event location grid at one or more anchor points on the event location grid, and
cause presentation, in real-time responsive to receiving the request from the remote computing device, of a graphical user interface indicating the computed amount of risk exposure to the one or more locations from the event.

3. The system of claim 2, wherein the machine-executable instructions, when executed on the processing circuitry, further cause the processing circuitry to:
classify, in real-time responsive to receiving the request from the remote computing device, the event as a catastrophic event using a plurality of catastrophic event criteria, wherein the catastrophic event corresponds to an event having a likelihood of triggering insurance coverage.

4. The system of claim 2, wherein the plurality of catastrophic event criteria comprises at least one of an event type, a severity level of the event, and a coverage area of the event.

5. The system of claim 2, wherein generating the event location grid further comprises determining, based at least in part on one or more characteristics of the event, the grid cell resolution, wherein
the one or more characteristics include a type of event and a coverage area of the event.

6. The system of claim 2, wherein generating the event location grid further comprises associating a location of the event with stored geocoded location data including a plurality of locations for a plurality of types of catastrophic events.

7. The system of claim 2, wherein generating the event location grid further comprises selecting the one or more locations for the event from the plurality of locations of the stored geocoded location data based on one or more characteristics of the event.

8. The system of claim 2, wherein generating the event location grid further comprises assigning a numerical value to each of the plurality of cells of the event location grid corresponding to a coverage amount from the one or more locations positioned within each of the plurality of cells.

9. The system of claim 2, wherein a result of the convolution calculation at a first anchor point associated with a cell of the event location grid not associated with the one or more locations represents an indirect risk exposure amount to the one or more locations, wherein
the indirect exposure amount corresponds to risk exposure that occurs to locations outside of a direct coverage area of the event.

10. The system of claim 2, wherein a result of the convolution calculation at a second anchor point associated with a cell of the event location grid including at least one of the one or more locations represents a direct risk exposure amount to the one or more locations, wherein
the direct exposure amount corresponds to risk exposure that occurs to locations within a direct coverage area of the event.

11. The system of claim 2, wherein computing the amount of risk exposure to the one or more locations due to the at least one catastrophic event comprises executing a circular convolution calculation of the event footprint grid with the event location grid using a fast Fourier Transform (FFT).

12. The system of claim 2, wherein generating the event footprint grid further comprises associating the event with an event template shape of a plurality of event template shapes of stored spatial library data, wherein association of the event template shape with the event is based at least in part on characteristics of the event.

13. The system of claim 12, wherein generating the event footprint grid further comprises assigning a numerical value to each of the plurality of cells of the event footprint grid corresponding to a coverage ratio representative of a portion of each of the plurality of cells that is covered by the event template shape.

14. The system of claim 12, wherein the associated event template shape comprises a plurality of nested polygons, wherein
each of the plurality of nested polygons represents one of a plurality of catastrophic events.

15. The system of claim 2, wherein the machine-executable instructions, when executed on the processing circuitry, further cause the processing circuitry to identify, based on results of the convolution calculation executed at the one or more anchor points on the event location grid, one or more highest risk exposure areas for the one or more locations due to the event.

16. A method comprising:
receiving, from a user at a remote computing device, a request for an assessment of risk exposure due to a plurality of event occurrences within a geographic region of interest;
identifying, by processing circuitry of a computing system responsive to receiving the request, one or more points of interest associated with the user within the geographic region of interest;
applying, by the processing circuitry, a plurality of historic event shapes against the one or more points of interest at a plurality of locations within the geographic region of interest, wherein
each of the plurality of historic event shapes corresponds to a respective event occurrence of the plurality of event occurrences,
each location of the plurality of locations corresponds to a point of interest of the one or more points of interest, and
applying the plurality of historic event shapes comprises, for each of the plurality of historic event shapes,
obtaining an event location grid having a plurality of cells, wherein at least a portion of the cells correspond to a portion of the one or more locations,
obtaining an event footprint grid representative of a geographic coverage area of the event, wherein the event footprint grid includes a plurality of cells having a resolution corresponding to a grid cell resolution of the event location grid, and
computing an amount of risk exposure to the one or more locations due to the event based on execution of a convolution calculation of the event footprint grid with the event location grid at one or more anchor points on the event location grid; and
returning, to the user at the remote computing device via a graphical user interface in real-time responsive to receiving the request, an assessment indicating a likelihood of risk exposure for each of the one or more points of interest due to each of the plurality of event occurrences.

17. The method of claim 16, wherein obtaining the event location grid comprises generating the event location grid.

18. The method of claim 16, further comprising determining an amount of indirect risk exposure to the user by applying the plurality of historic event shapes at one or more locations in addition to the plurality of locations, wherein
each location of the one or more locations is external to the one or more points of interest.

19. The method of claim 16, further comprising determining an amount of direct risk exposure to the user by applying the plurality of historic event shapes at the one or more points of interest.

20. The method of claim 16, wherein the plurality event occurrences are man-made or natural catastrophic event occurrences having a likelihood of triggering insurance coverage.
